(19) United States
(12) Patent Application Publication
(10) Pub. No.: US 2011/0125987 A1
(43) Pub. Date: May 26, 2011

(54) Dedicated Arithmetic Decoding Instruction

(75) Inventors: Erich James Plondke, Austin, TX (US); Lucian Codrescu, Austin, TX (US); Ajay Anant Ingle, Austin, TX (US); Mao Zeng, Austin, TX (US); Christopher Edward Koob, Round Rock, TX (US); Charles Joseph Tabony, Austin, TX (US)

(73) Assignee: QUALCOMM INCORPORATED, San Diego, CA (US)

(21) Appl. No.: 12/622,998

(22) Filed: Nov. 20, 2009

(51) Int. Cl. G06F 9/30; G06F 9/302

(52) U.S. Cl. 712/208; 712/221; 712/E09.016; 712/E09.017

(57) ABSTRACT

A dedicated arithmetic decoding instruction is disclosed. In a particular embodiment, an apparatus includes a memory and a processor coupled to the memory. The processor is configured to execute general purpose instructions and to execute a dedicated arithmetic decoding instruction retrieved from the memory.

### I. FIELD

The present disclosure is generally related to microprocessor instructions.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. Wireless telephones can also include video download and video playback capabilities. As such, these wireless telephones can include significant computing capabilities.

To achieve efficient data transfer, a video bitstream representing a video file may be encoded during transmission to computing devices such as wireless telephones. The video bitstream may also be stored in compressed fashion at the computing devices in order to achieve more efficient utilization of storage space. When the video file is played at a computing device, the computing device may decode the encoded video bitstream. As video encoding methods become more complex, video decoding becomes an increasingly complex computational problem. Further, although parallel processing techniques have improved the speed at which computing devices can perform certain tasks, video decoding may not be significantly improved by parallel processing due to its serial nature (i.e., the ability to decode a particular bit depends on successfully decoding one or more of the preceding bits).

### III. SUMMARY

A dedicated arithmetic decoding instruction and logic to execute a dedicated arithmetic decoding instruction is disclosed. The dedicated arithmetic decoding instruction may reduce the amount of processor time to decode an arithmetically encoded video stream. A processor may execute the dedicated arithmetic decoding via computational logic. The computational logic may enable the processor to execute, via a single instruction, a decoding algorithm that would otherwise require several general purpose instructions.

In a particular embodiment, an apparatus is disclosed that includes a memory and a processor coupled to the memory. The processor is configured to execute general purpose instructions. The processor is also configured to execute a dedicated arithmetic decoding instruction retrieved from the memory.

In another particular embodiment, a method is disclosed that includes executing a dedicated context adaptive binary arithmetic coding (CABAC) decoding instruction during a first execution cycle of a processor. The dedicated CABAC decoding instruction accepts as input a first range, a first offset, and a first state. The method also includes storing a second state based on one or more outputs of the dedicated CABAC decoding instruction during a second execution cycle of the processor. The method further includes realigning the first range based on the one or more outputs of the dedicated CABAC decoding instruction to produce a second range during the second execution cycle of the processor. The method includes realigning the first offset based on the one or more outputs of the dedicated CABAC decoding instruction to produce a second offset during the second execution cycle of the processor.

In yet another particular embodiment, an apparatus is disclosed that includes a memory and a processor coupled to the memory. The processor includes means for executing general purpose instructions and means for executing a dedicated arithmetic decoding instruction.

One particular advantage provided by at least one of the disclosed embodiments is the ability to program and execute a dedicated arithmetic decoding instruction at a microprocessor. Dedicated arithmetic decoding instructions may reduce the number of processor execution cycles taken to decode an entropy-encoded video bitstream (e.g., an H.264 CABAC video bitstream).

Other aspects, advantages, and features of the present disclosure will become apparent after review of the entire application, including the following sections: Brief Description of the Drawings, Detailed Description, and the Claims.

### IV BRIEF DESCRIPTION OF THE DRAWINGS

FIG. 1 is a block diagram of a particular illustrative embodiment of a system to execute a dedicated arithmetic decoding instruction;

FIG. 2 is a diagram of a particular illustrative embodiment of a method of storing information in registers of a processor configured to execute a dedicated arithmetic decoding instruction;

FIG. 3 is an architectural diagram of a particular illustrative embodiment of processing logic to execute a dedicated arithmetic decoding instruction;

FIG. 4 is a flow diagram of a particular illustrative embodiment of a method to execute a dedicated arithmetic decoding instruction;

FIG. 5 is a flow diagram of another particular illustrative embodiment of a method to execute a dedicated arithmetic decoding instruction; and

FIG. 6 is a block diagram of portable device including logic to execute a dedicated arithmetic decoding instruction.

### V DETAILED DESCRIPTION

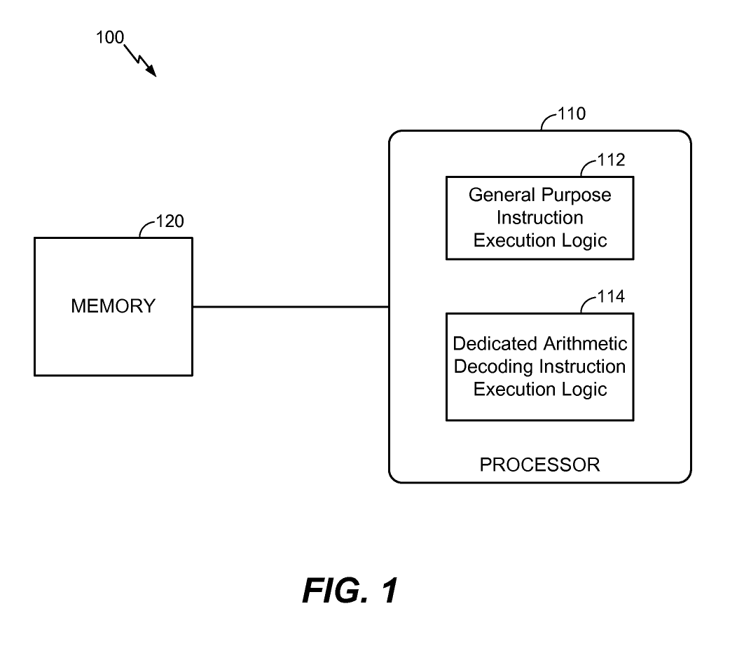

Referring to FIG. 1, a particular illustrative embodiment of a system to execute a dedicated arithmetic decoding instruction is disclosed and generally designated 100. The system 100 includes a processor 110 coupled to a memory 120.

The processor 110 includes general purpose instruction execution logic 112 configured to execute general purpose instructions. General purpose instructions may include commonly executed processor instructions, such as LOADs, STOREs, and JUMPS. The general purpose execution logic 112 may include general purpose load-store logic to execute the general purpose instructions. The processor 110 also includes dedicated arithmetic decoding instruction execution logic 114 configured to execute a dedicated arithmetic decoding instruction. The dedicated arithmetic decoding instruction may be executable by the processor 110 to decode a video stream encoded in an entropy coding scheme, such as the context adaptive binary arithmetic coding (CABAC) scheme. In a particular embodiment, the dedicated arithmetic decoding instruction may be used in decoding a video stream that is CABAC-encoded in accordance with the two-hundred and sixty-fourth audiovisual and multimedia systems standard promulgated by the International Telecommunications Union (H.264, entitled “Advanced video coding for generic audiovisual services”).

In a particular embodiment, the general purpose instructions and the dedicated arithmetic decoding instruction are executed by a common execution unit of the processor 110. For example, the common execution unit may include both the general purpose instruction execution logic 112 and the dedicated arithmetic decoding instruction execution logic 114. In another particular embodiment, the dedicated arithmetic decoding instruction is an atomic instruction that is executable by the processor 110 without separating the dedicated arithmetic decoding instruction into one or more general purpose instructions to be executed by the general purpose instruction execution logic 112. The dedicated arithmetic decoding instruction may be a single instruction of an instruction set of the processor 110 and may be executable in a small number of cycles (e.g., less than three execution cycles) of the processor 110. In a particular embodiment, the processor 110 is a pipelined multi-threaded very long instruction word (VLIW) processor.

The memory 120 may include random access memory (RAM), read only memory (ROM), register memory, or any combination thereof. Although the memory 120 is illustrated in FIG. 1 as being separate from the processor 110, the memory 120 may instead be an onboard memory (e.g., cache) of the processor 110.

In operation, the processor 110 may be used in decoding an encoded video stream. While decoding a particular bit of the video stream, the processor 110 may retrieve a dedicated arithmetic decoding instruction from the memory 120 and the logic 114 may execute the retrieved instruction.

It will be appreciated that the system 100 of FIG. 1 may enable the execution of a dedicated arithmetic decoding instruction (e.g., while decoding video streams). Processors configured to execute dedicated arithmetic decoding instructions (e.g., the processor 110) may decode video streams faster than processors that execute a video decoding algorithm as multiple general purpose instructions. For example, the ability to execute a dedicated arithmetic decoding instruction may enable a processor to perform otherwise complex and time-consuming decoding operations in fewer execution cycles than by using general purpose instructions.

CABAC is a form of binary arithmetic coding. Generally, binary arithmetic coding may be characterized by two quantities: a current interval “range” and a current “offset” in the current interval range. To decode a particular CABAC-encoded bit, the current range is first subdivided into two portions based on the probability of a least probable symbol (LPS) and a most probable symbol (MPS). For example, the LPS may be a one symbol, the MPS may be a zero symbol, and the current range may be the range between zero and one. Generally, if R is the width of the current range, rLPS is the width of the first portion, rMPS is the width of the second portion, pLPS is the probability of encountering the least probable symbol, and pMPS is the probability of encountering the most probable symbol, then rLPS=R×pLPS and rMPS=R×pMPS=R−rLPS. Thus, when the probability pLPS of the least probable symbol is higher than the probability pMPS of the most probable symbol, the portion corresponding to the least probable symbol will have a larger width rLPS than the width rMPS of the portion corresponding to the most probable symbol. That is, when pLPS>pMPS, rLPS>rMPS. Similarly, when pMPS>pLPS, rMPS>rLPS. Depending on whether the current offset occurs within rLPS or rMPS, the values of rLPS and rMPS are iteratively updated during decoding of the video stream.

For example, rMPS may initially be equal to 0.50, and rLPS may initially be equal to 0.50. That is, the probability of encountering an MPS may initially be 50% and the probability of encountering an LPS may initially be 50%. If the current offset falls within rMPS (i.e., an MPS is encountered), rMPS may be increased and rLPS may be decreased. For example, rMPS may be increased to 0.75 and rLPS may be decreased to 0.25. As another example, rMPS may initially be equal to 0.875 and rLPS may initially be equal to 0.125. If the current offset falls within rLPS, rMPS may be decreased to 0.75 and rLPS may be increased to 0.25.

Decoding a video stream that is CABAC-encoded in accordance with H.264 may be a stateful operation. That is, decoding the video stream may require the maintenance of information (e.g., state, bit position, and MPS bit) other than the range and offset. For H.264, the range is a 9-bit quantity and the offset is an at least 9-bit quantity. The calculation of rLPS may be approximated by a 64×4 lookup table of 256 bytes that stores CABAC constants and that is indexed by range and state. Because the values in the lookup table are constants defined by the H.264 standard, the lookup table may be hard-coded. Alternately, the lookup table may be programmable (e.g., rewriteable).

A dedicated CABAC decoding instruction may realign the range, realign the offset, and lookup CABAC constants as described herein. Such a dedicated CABAC decoding instruction may accept as input CABAC state bits, a CABAC MPS bit, bit position (bitpos) bits, nine CABAC range bits, and at least nine CABAC offset bits. The dedicated CABAC decoding instruction may generate an output including new CABAC state bits, a new CABAC MPS bit, nine CABAC range bits, at least nine CABAC offset bits, and an output value bit representing the decoded bit of the video stream. In a particular embodiment, the decoding process is renormalized as necessary after each iteration such that the value of the MPS bit is always 1. For example, a dedicated CABAC decoding instruction may operate in accordance with the following pseudo-code:

| range <<= bitpos; | |
|---|---|
| offset <<= bitpos; | |
| rLPS= rLPS_table_64×4[state][(range >>29)&3]; | |
| // left aligned rLPS | |
| rLPS = rLPS << 23; | |
| // calculate rMPS | |
| // only need 9-bit subtraction on MSB | |
| rMPS= range − rLPS; | |
| if (offset < rMPS) { | |
| range = rMPS; | |
| bin = valMPS; | |
| //fetch new state from constants table | |
| state = AC_next_state_MPS_64[state]; | |
| } | |
| else { | |
| range = rLPS; | |
| offset = offset − rMPS; | |
| bin = valMPS\hat{ }1; | |
| if (!state) | |
| valMPS = 1−valMPS; | |
| //fetch new state from constants table | |
| state = AC_next_state_LPS_64[state]; | |
| } | |
| // Note: only 9 MSB bits are used for calculation | |
| // AC_next_state_MPS_64 table can be simplified as | |
| //AC_next_state_MPS_64[state] = (state<62)? (state+1) : | |
| // | state; |

It should be noted that although many of the equations and expressions as set forth herein use a syntax similar to the C or C++ programming language, the expressions are for illustrative purposes and may instead be expressed in other programming languages with different syntax.

The above pseudo-code may be encapsulated into a function DECBIN( ) and a decoded H.264 video bit may be produced in two processor cycles as follows:

| //Input: R1:0 = offset:range, R2=dep, R3=state | |
|---|---|
| // R4 = (*state), R5 = bitpos | |
| //RETURN: R1:0 = offset:range, P0 = (bin) | |
| //Cycle 1 | |
| { (P0,R1:0 = DECBIN(R1:0,R5:4) | //decode one bin |
| R6 = ASL(R22,R5) | //where R22=0x100 |
| } | |
| //Cycle 2 | |

| | |
|---|---|
| { MEMB(R3) = R0 | //save context to *state |
| R1:0 = VLSRW(R1:0,R5) | //re-align range and offset |
| P1 = CMP.GTU(R6,R1) | //i.e. P1=(range<0x100) |
| IF !P1.new JUMPR:t R31 | //return |
| } | |
| RNRM_RFIL: | |
| . . . | |

The function DECBIN( ) may also be used without the speculative JUMPR:t R31 (i.e., jump to address in register 31) instruction as follows:

| | |
|---|---|
| //Cycle 1 | |
| { (P0,R7:6 = DECBIN(R1:0,R5:4) | //decode one bin |
| P1 = CMP.GTU(R0,#255) | // P1=!(range<0x100) |
| IF !P1.new JUMP:nt RNRM_RFIL | //renormalize and refill |
| } | |
| //Cycle 2 | |

| | |
|---|---|
| { MEMB(R3) = R6 | //save context to *state |
| R1:0 = VLSRW(R7:6,R5) | //re-align range and offset |
| JUMPR R31 | //return |
| } | |
| RNRM_RFIL: | |
| . . . | |

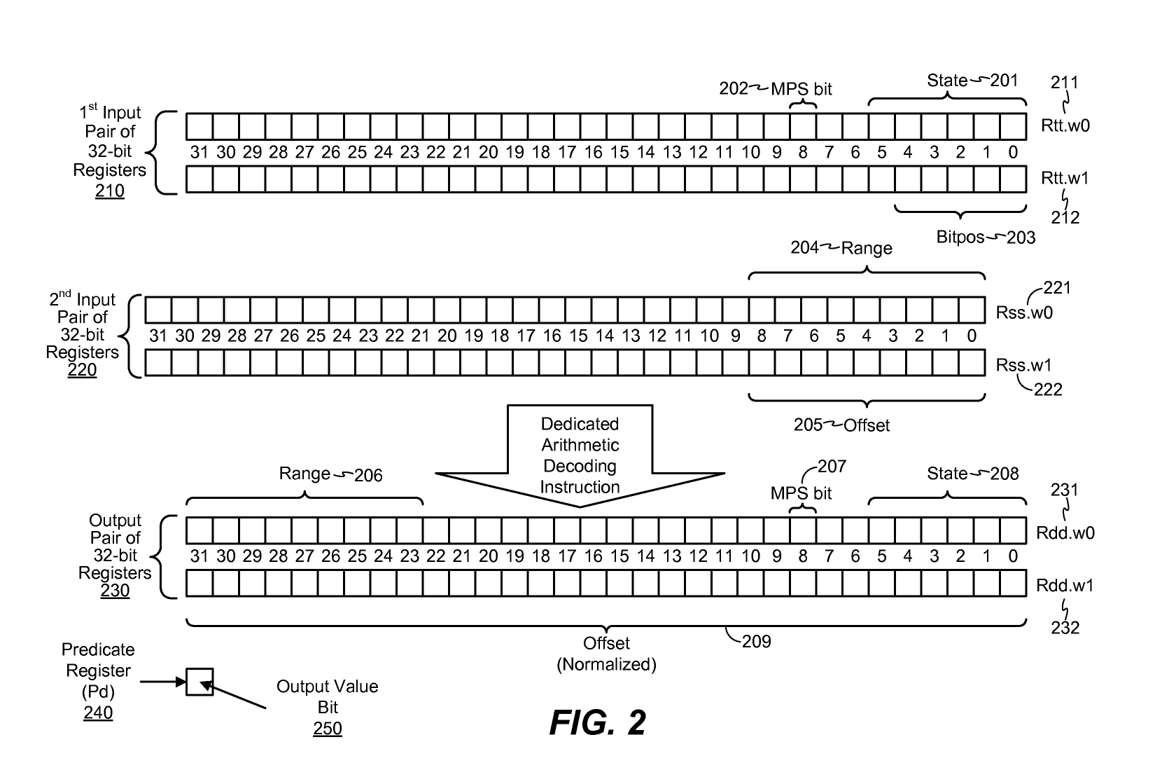

Referring to FIG. 2, a diagram of a particular illustrative embodiment of a method of storing information in registers of a processor configured to execute a dedicated arithmetic decoding instruction is disclosed. In an illustrative embodiment, the dedicated arithmetic decoding instruction is a H.264 CABAC decoding instruction. A processor, such as the processor 110 of FIG. 1, may load and store the data required to execute a dedicated arithmetic decoding instruction in two input register pairs 210 and 220. In a particular embodiment, the register pairs 210 and 220 are pairs of 32-bit registers.

The processor may store data generated during execution of the dedicated arithmetic decoding instruction in an output register pair 230 and an output predicate register 240. In a particular embodiment, the output register pair 230 is a pair of 32-bit registers.

For example, a first register Rtt.w0 211 of the first input register pair 210 may store an input state 201 and an input MPS bit 202. In a particular embodiment, bits zero to five of Rtt.w0 211, denoted Rtt.w0[0:5], store the input state 201 and Rtt.w0[8] stores the input MPS bit 202. A second register Rtt.w1 212 of the first input register pair 210 may store an input bitpos 203. For example, Rtt.w1 [0:4] may store the input bitpos 203.

A first register Rss.w0 221 of the second input register pair 220 may store an input range 204. For example, Rss.w0[0:9] may store the nine bits of the input range 204. A second register Rss.w1 222 of the second input register pair 220 may store an input offset 205. In a particular embodiment, at least Rss.w1[0:8] stores the at least nine bits of the input offset 205.

A first register Rdd.w0 231 of the output register pair 230 may store an output state, an output MPS bit, and an output range. For example, Rdd.w0[0:5] may store the 6-bit output state, Rdd.w0[8] may store the output MPS bit, and Rdd.w0[23:31] may store the output range. A second register Rdd.w1 232 of the output register pair 231 may store an output offset 209 in a normalized fashion. An output value bit 250 of the dedicated CABAC decoding instruction may be stored in a predicate register 240. In a particular embodiment, the output value bit 250 stored in the predicate register 240 may be input into subsequent instructions (e.g., general purpose instructions or a subsequent dedicated CABAC decoding instruction) executed by the processor. For example, the output value bit 250 stored in the predicate register 240 may be used in a decision in the video decoding algorithm.

It will be appreciated that a processor may “pack” the input data for a dedicated CABAC decoding instruction into just two input register pairs and may “pack” the output data for the dedicated CABAC decoding instruction into one output register pair and a predicate register. In a particular embodiment, the use of a dedicated CABAC decoding instruction may reduce the time taken to generate a decoded video stream bit from 7 processor execution cycles (using general purpose instructions) to 2 processor execution cycles. It should be noted that although the dedicated CABAC decoding instruction has been explained herein with reference to the H.264 video compression standard, the instruction may be used in decoding other arithmetically coded bitstreams. For example, the instruction may be used in decoding bitstreams encoded in accordance with the Joint Photographic Experts Group 2000 (JPEG2000) image compression standard. It should be noted that although FIG. 2 illustrates two input register pairs, one output register pair, and an output predicate register, the dedicated CABAC decoding instruction may alternately be performed using any number and combination of input and output registers. It should further be noted that although the dedicated CABAC decoding instruction as described herein utilizes a 9-bit range and an at least 9-bit offset, such bit lengths are for illustrative purposes only. Other arithmetic decoding algorithms may use other variable bit lengths, and dedicated arithmetic decoding instructions as described herein may accept as input and generate as output data of any bit length.

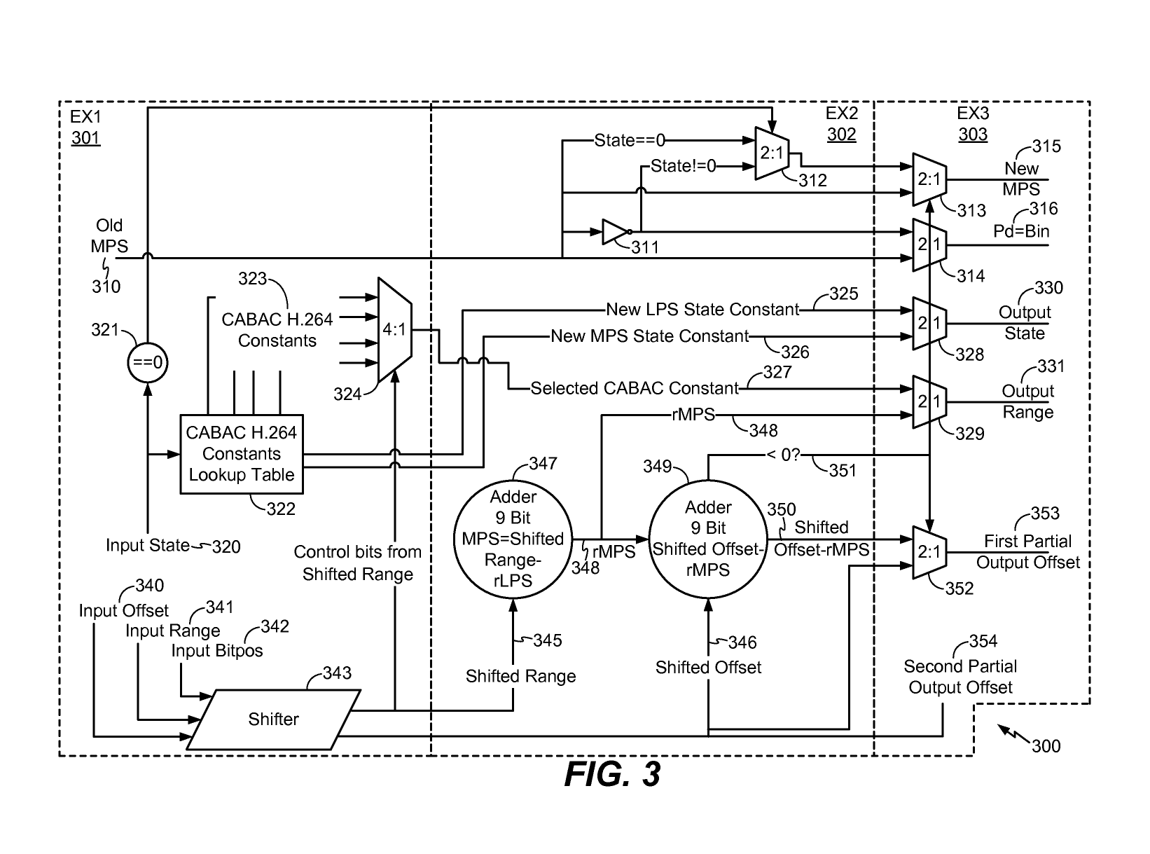

Referring to FIG. 3, an architectural diagram of a particular illustrative embodiment of logic to execute a dedicated arithmetic decoding instruction is illustrated and generally designated 300. In an illustrative embodiment, the dedicated arithmetic decoding instruction is a H.264 CABAC decoding instruction.

The logic 300 may be divided into three execution stages: EX1 301, EX2 302, and EX3 303. In a particular embodiment, each execution stage corresponds to a particular execution pipeline stage of a pipelined processor. In a particular embodiment, the execution stages 301, 302, and 303 occur during a single execution cycle of the pipelined processor. During the first execution stage EX1 301, five input variables are retrieved: an old MPS value 310, an input state 320, an input offset 340, an input range 341, and an input bitpos 342. In a particular embodiment, the input variables 310, 320, 340, 341, and 342 are packed into input register pairs as described herein with reference to FIG. 2. The old MPS value 310 passes from EX1 301 to EX2 302.

The input state 320 is used as an index into a CABAC H.264 constants lookup table 322. Four CABAC constants 323 are produced as a result of the index operation and input into a 4-to-1 multiplexer 324 that outputs a selected CABAC constant 327. The index operation also produces a new LPS state constant 325 and a new MPS state constant 326, both of which are passed to EX2 302 along with the selected CABAC constant 327. The input state 320 is also applied to a zero comparator 321, and the resulting output from the zero comparator 321 passes from EX1 301 to EX2 302.

Each of the input offset 340, the input range 341, and the input bitpos 342 are applied to a shifter 343. The shifter 343 produces a shifted range 345 and a shifted offset 346 as output. Control bits 344 from the shifted range 345 are applied to the 4-to-1 multiplexer 324 as control bits. The shifted range 345 and the shifted offset 346 are also passed from EX1 301 to EX.

During EX2 302, the old MPS value 310 is inverted by an inverter 311. The old MPS value 310 is also applied to a first 2-to-1 multiplexer 312 that is controlled by the output of the zero comparator 321. The output of the inverter 311 is also applied to the first 2-to-1 multiplexer 312. The old MPS value 310, the output of the inverter 311, and the output of the first 2-to-1 multiplexer 312 are passed from EX2 302 to EX3 303. The new LPS state constant 325, the new MPS state constant 326, and the selected CABAC constant 327 are also passed from EX2 302 to EX3 303.

The shifted range 345 is applied to a first 9-bit adder 347 that calculates rMPS 348 in accordance with the formula rMPS=Shifted Range−rLPS. rMPS 348 is then applied with the shifted offset 346 to a second 9-bit adder 349 that produces as output 350 the difference between the shifted offset 346 and rMPS 348. rMPS 348, the output 350 of the second 9-bit adder 349, and the shifted offset 346 are passed from EX2 302 to EX3 303. The second 9-bit adder 349 also generates a control bit 351 responsive to whether or not the output 350 of the 9-bit adder 349 is less than zero. In a particular embodiment, the control bit 351 is generated by checking a sign bit of the output 350. The control bit 351 also passes from EX to EX3 303.

During EX3 303, the output of the first 2-to-1 multiplexer 312 and the old MPS value 310 are applied to a second 2-to-1 multiplexer 313 that outputs a new MPS value 315. The output of the inverter 311 and the old MPS value 310 are applied to a third 2-to-1 multiplexer 314 that outputs a predicate output value bit Pd 316.

The new LPS state constant 325 and the new MPS state constant 326 are input into a fourth 2-to-1 multiplexer 328 that outputs an output state 330. The selected CABAC constant 327 and rMPS 348 are input to a fifth 2-to-1 multiplexer that outputs an output range 331.

The output 350 of the second 9-bit adder 349 and the shifted offset 346 are applied to a sixth 2-to-1 multiplexer 352 that outputs a first partial output offset 353. The shifted offset 346 is stored as a second partial output offset 354. Each of the 2-to-1 multiplexers 313, 314, 328, 329, and 352 is controlled via the control bit 351. In an illustrative embodiment, the output variables 315, 330, 331, 353, and 354 are packed into an output register pair and the predicate output value bit Pd 316 is stored in a predicate register as described herein with reference to FIG. 2.

It will be appreciated that because many processors include a shifter, the logic 300 of FIG. 3 may be implemented in such processors by storing the lookup table 322 and adding a few simple circuit elements, such as comparators, adders, inverters, and multiplexers. Thus, a processor may be configured to execute a dedicated arithmetic decoding instruction by implementing the logic 300 of FIG. 3 without requiring substantial changes to existing data paths and pipeline stages of the processor.

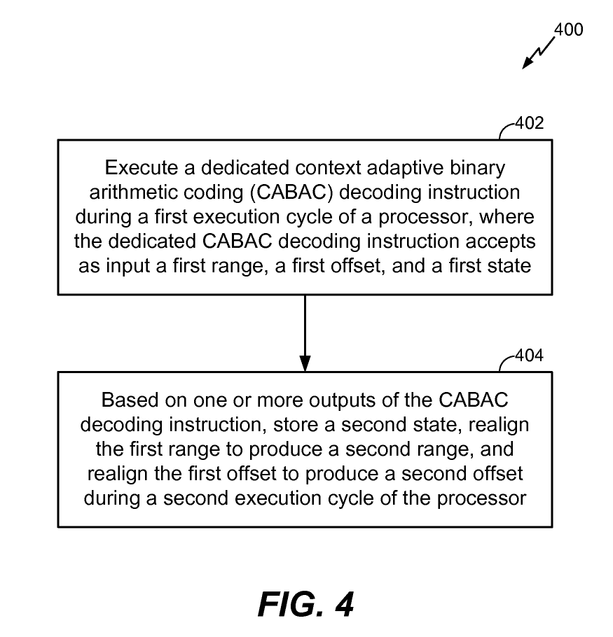

Referring to FIG. 4, a flow diagram of a particular illustrative embodiment of a method to execute a dedicated arithmetic decoding instruction is illustrated and generally designated 400. In an illustrative embodiment, the method 400 may be performed by the processor 110 of FIG. 1 or the logic 300 of FIG. 3.

The method 400 includes executing a dedicated CABAC decoding instruction during a first execution cycle of a processor, at 402. The dedicated CABAC decoding instruction accepts as input a first range, a first offset, and a first state. For example, in FIG. 3, the logic 300 may execute a dedicated CABAC decoding instruction that accepts as input the input range 341, the input offset 342, and the input state 320 by executing the execution stages EX1 301, EX2 302, and EX3 303 during a first execution cycle of a processor.

The method 400 also includes, based on one or more outputs of the CABAC decoding instruction, storing a second state, realigning the first range to produce a second range, and realigning the first offset to produce a second offset during a second execution cycle of the processor, at 404. For example, in FIG. 3, the output state 330 the output range 331, the first partial output offset 353, and the second partial output offset 354 may be stored during a second execution cycle of the processor.

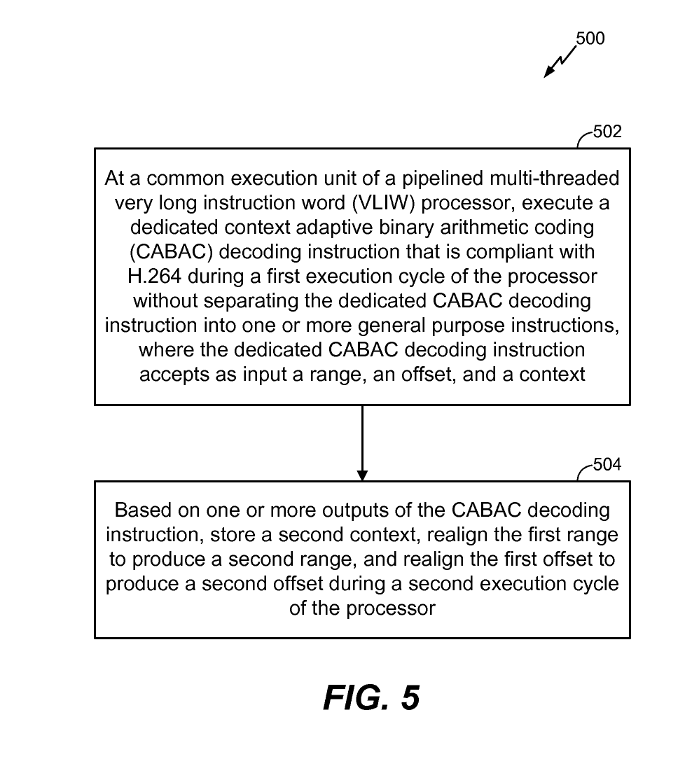

Referring to FIG. 5, a flow diagram of another particular illustrative embodiment of a method to execute a dedicated arithmetic decoding instruction is illustrated and generally designated 500. In an illustrative embodiment, the method 500 may be performed by the processor 110 of FIG. 1 or the logic 300 of FIG. 3.

The method 500 includes executing a dedicated CABAC decoding instruction during a first execution cycle of a processor, at 502. The processor may be a pipelined multi-threaded VLIW processor and the dedicated CABAC decoding instruction may be executed at a common execution unit of the processor without separating the dedicated CABAC decoding instruction into one or more general purpose instructions. The dedicated CABAC decoding instruction accepts as input a first range, a first offset, and a first state. The dedicated CABAC decoding instruction may be compliant with the H.264 video compression standard. For example, referring FIG. 3, the logic 300 may execute a dedicated CABAC decoding instruction that accepts as input the input range 341, the input offset 342, and the input state 320 by executing the execution stages EX1 301, EX2 302, and EX3 303 during a first execution cycle of a processor.

The method 500 also includes, based on one or more outputs of executing the CABAC decoding instruction, storing a second state, realigning the first range to produce a second range, and realigning the first offset to produce a second offset during a second execution cycle of the processor, at 504. For example, referring to FIG. 3, the output state 330, the output range 331, the first partial output offset 353, and the second partial output offset 354 may be stored during a second execution cycle of the processor.

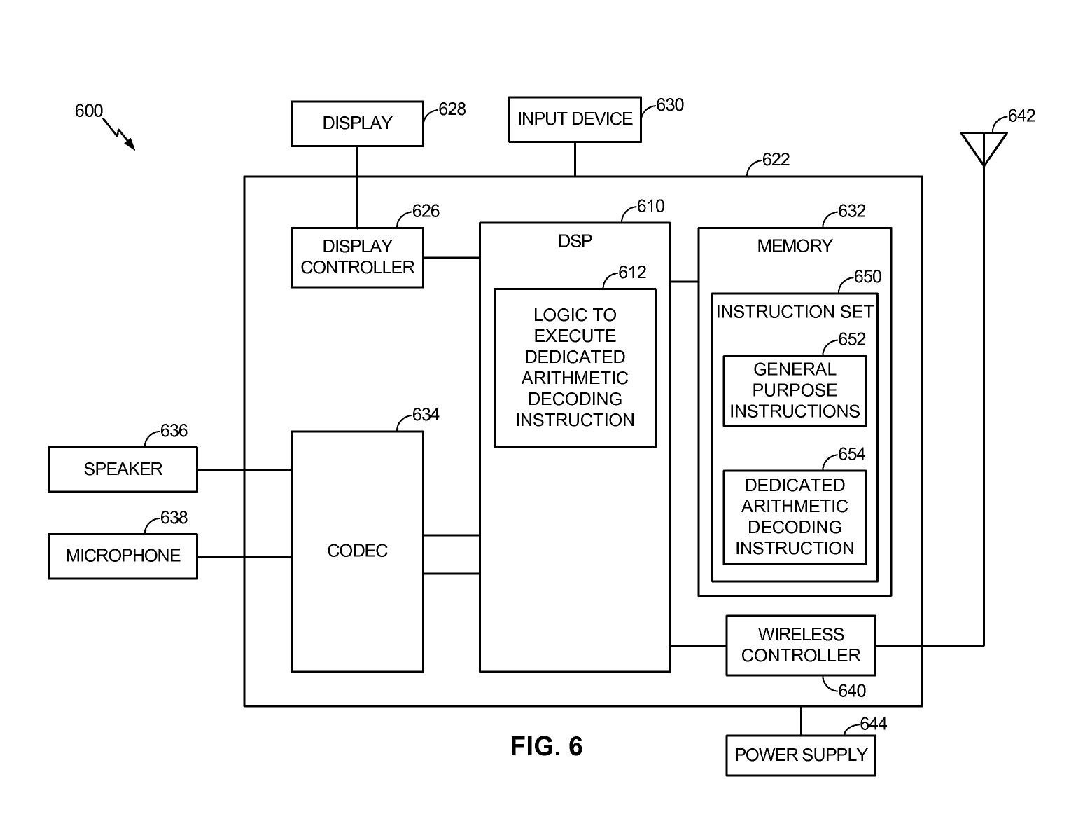

FIG. 6 is a block diagram of a wireless device 600 that includes an instruction set 650 having general purpose instructions 652 and a dedicated arithmetic coding instruction 654. In a particular embodiment, the instruction set 650 or portions thereof are used in a decoding application or some other decoding software that is stored at the memory 632. The wireless device 600 also includes logic 612 to execute the dedicated arithmetic decoding instruction 654. In an illustrative embodiment, the logic 612 includes the logic 300 of FIG. 3. In a particular embodiment, the logic 612 is a common execution unit of the DSP 610 that is configured to execute general purpose instructions.

The wireless device 600 includes a processor, such as a digital signal processor (DSP) 610, coupled to a memory 632. In an illustrative embodiment, the DSP 610 may include the processor 110 of FIG. 1, and the memory 632 may include the memory 120 of FIG. 1. The memory 632 may be a computer-readable tangible storage medium.

As illustrated in FIG. 6, the instruction set 650 includes both general purpose instructions 652 as well as a dedicated arithmetic decoding instruction 654. In a particular embodiment, the instruction set 650 enables the wireless device 600 to decode an H.264-compliant CABAC-encoded video stream. The logic 612 is employed by the DSP 610 to execute the dedicated arithmetic decoding instruction 654. In a particular embodiment, executing the dedicated arithmetic decoding instruction 654 includes retrieving, processing, and storing data as described herein with respect to FIG. 2.

FIG. 6 also shows an optional display controller 626 that is coupled to the digital signal processor 610 and to a display 628. A coder/decoder (CODEC) 634 can also be coupled to the digital signal processor 610. A speaker 636 and a microphone 638 can be coupled to the CODEC 634. FIG. 6 also indicates that a wireless interface 640 can be coupled to the digital signal processor 610 and to a wireless antenna 642. In a particular embodiment, the DSP 610, the display controller 626, the memory 632, the CODEC 634, and the wireless interface 640 are included in a system-in-package or system-on-chip device 622. In a particular embodiment, an input device 630 and a power supply 644 are coupled to the system-on-chip device 622. Moreover, in a particular embodiment, as illustrated in FIG. 6, the display 628, the input device 630, the speaker 636, the microphone 638, the wireless antenna 642, and the power supply 644 are external to the system-on-chip device 622. However, each can be coupled to a component of the system-on-chip device 622, such as via an interface or a controller. In an illustrative embodiment, the wireless device 600 is a cellular telephone, a smartphone, or a personal digital assistant (PDA). Thus, the wireless device 600 may receive an encoded video stream via the antenna 642, the instruction set 650 (including both the general purpose instructions 652 and one or more of the dedicated arithmetic decoding instruction 654) may be executed by the logic 612 of the DSP 610, and the resulting decoded video stream may be displayed at the display 628.

It should be noted that although the particular embodiment illustrated in FIG. 6 includes a wireless device 600, the logic 612 and the instruction set 650 may alternatively be included in other devices, such as a set-top box, a music player, a video player, an entertainment unit, a navigation device, a communications device, a fixed location data unit, or a computer.

Those of skill would further appreciate that the various illustrative logical blocks, configurations, modules, circuits, and method steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), magneto-resistive RAM (MRAM), spin torque tunnel MRAM (STT-MRAM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a memory; and
a processor coupled to the memory, the processor configured to execute general purpose instructions and to execute a dedicated arithmetic decoding instruction retrieved from the memory.

2. The apparatus of claim 1, wherein the dedicated arithmetic decoding instruction is executable by the processor to decode a video stream encoded in an entropy coding scheme.

3. The apparatus of claim 2, wherein the entropy coding scheme is context adaptive binary arithmetic coding (CABAC).

4. The apparatus of claim 3, wherein the dedicated arithmetic decoding instruction accepts as input six CABAC state bits, a CABAC most probable symbol (MPS) bit, five bit position (bitpos) bits, nine CABAC range bits, and at least nine CABAC offset bits.

5. The apparatus of claim 4, further comprising a first input register pair and a second input register pair, wherein the six CABAC state bits and the CABAC MPS bit are retrieved from a first 32-bit register of the first input register pair, wherein the five CABAC bitpos bits are retrieved from a second 32-bit register of the first input register pair, wherein the nine CABAC range bits are retrieved from a first 32-bit register of the second input register pair, and wherein the at least nine CABAC offset bits are retrieved from a second 32-bit register of the second input register pair.

6. The apparatus of claim 3, wherein the dedicated arithmetic decoding instruction generates an output including six CABAC state bits, a CABAC MPS bit, nine CABAC range bits, at least nine CABAC offset bits, and a predicate output value bit.

7. The apparatus of claim 6, further comprising an output register pair and a predicate register, wherein the six CABAC state bits, the CABAC MPS bit, and the nine CABAC range bits are stored in a first 32-bit register of the output register pair, wherein the at least nine CABAC offset bits are stored in a normalized fashion in a second 32-bit register of the output register pair, and wherein the predicate output value bit is stored in the predicate register.

8. The apparatus of claim 7, wherein the processor is further configured to execute one or more instructions that accept as input the predicate output value bit stored in the predicate register.

9. The apparatus of claim 1, wherein the dedicated arithmetic decoding instruction is compliant with the H.264 video compression standard.

10. The apparatus of claim 1, wherein the general purpose instructions and the dedicated arithmetic decoding instruction are executed by a common execution unit of the processor.

11. The apparatus of claim 1, wherein the dedicated arithmetic decoding instruction is executable by the processor without separating the dedicated arithmetic decoding instruction into one or more general purpose instructions.

12. The apparatus of claim 1, wherein the dedicated arithmetic decoding instruction is a single instruction of an instruction set of the processor.

13. The apparatus of claim 1, wherein the dedicated arithmetic decoding instruction is executable in less than three execution cycles of the processor.

14. The apparatus of claim 1, wherein the processor is a pipelined multi-threaded very long instruction word (VLIW) processor.

15. A method comprising:
executing a dedicated context adaptive binary arithmetic coding (CABAC) decoding instruction during a first execution cycle of a processor, wherein the dedicated CABAC decoding instruction accepts as input a first range, a first offset, and a first state; and
based on one or more outputs of the dedicated CABAC decoding instruction, storing a second state, realigning the first range to produce a second range, and realigning the first offset to produce a second offset during a second execution cycle of the processor.

16. The method of claim 15, wherein executing the dedicated CABAC decoding instruction comprises applying the first range and the first offset to a shifter.

17. The method of claim 15, wherein executing the dedicated CABAC decoding instruction comprises using the first state as an index into a CABAC lookup table stored at the processor.

18. The method of claim 17, wherein the CABAC lookup table is hard-coded.

19. The method of claim 17, wherein the CABAC lookup table is rewriteable.

20. A computer-readable tangible medium storing an instruction set executable by a processor, the instruction set comprising:
at least one general purpose instruction; and
at least one dedicated arithmetic decoding instruction.

21. The computer-readable storage medium of claim 20, wherein the at least one dedicated arithmetic decoding instruction is executable by the processor to decode a video stream encoded in context adaptive binary arithmetic coding (CABAC).

22. An apparatus comprising:
a memory; and
a processor coupled to the memory, the processor including means for executing general purpose instructions and means for executing a dedicated arithmetic decoding instruction.

23. The apparatus of claim 22, further comprising a device selected from the group consisting of a set top box, a music player, a video player, an entertainment unit, a navigation device, a communications device, a personal digital assistant (PDA), a fixed location data unit, and a computer, into which the memory means and the processor means are integrated.
